(19) United States
(12) Patent Application Publication
(10) Pub. No.: US 2026/0216988 A1
(43) Pub. Date: Jul. 30, 2026

(54) SANDWICH ELEMENT, MANUFACTURING METHOD AND CABIN ELEMENT

(71) Applicant: Airbus Operations GmbH, Hamburg (DE)

(72) Inventors: Tassilo Witte, Harburg (DE); Holger Buettemeyer, Hamburg (DE); Lisa Müller, Stade (DE)

(73) Assignee: Airbus Operations GmbH, Hamburg (DE)

(21) Appl. No.: 19/457,486

(22) Filed: Jan. 23, 2026

(30) Foreign Application Priority Data
Jan. 24, 2025 (EP) 25153892

(51) Int. Cl. B32B 3/26; B32B 3/30; B32B 5/18; B32B 27/06; B32B 27/28

(52) U.S. Cl. CPC B32B 3/266; B32B 3/30; B32B 5/18; B32B 27/065; B32B 27/281; B32B 27/286; B32B 2250/03; B32B 2250/40; B32B 2266/0214; B32B 2605/18

(57) ABSTRACT

The invention discloses a sandwich element having a foam core, which has at least one cover layer on each of its mutually opposite large surfaces, wherein recesses are introduced into the one large surface of the foam core, and the at least one cover layer extending over this large surface is provided with openings, which at least partially overlap with the recesses, a production method and a cabin element.

### DESCRIPTION

The invention relates to a sandwich element, to a method for producing such a sandwich element and to a cabin element for an aircraft cabin.

Cabin elements such as sidewall panels, ceilings, floors, partition walls, compartment walls of aircraft cabins generally consist of sandwich elements. Known sandwich elements have a honeycomb core, a front cover layer and a rear cover layer. The cover layers consist of a glass-fiber-reinforced phenol-based resin matrix. Such sandwich elements are characterized by high stability at a low weight. However, their limited sound-reducing effect is a disadvantage, and therefore when they are used as sidewall panels, it is necessary to arrange a relatively large amount of soundproofing material, for example in order to reduce engine noise.

The object of the invention is to provide a sandwich element that eliminates the aforementioned disadvantage, a method for producing such a sandwich element that is straightforward in terms of manufacturing and a cabin element with improved soundproofing.

This object is achieved by a sandwich element having the features of claim 1, by a method having the features of claim 8 and by a cabin element having the features of claim 9.

A sandwich element according to the invention, for example for a cabin element in an aircraft, has a foam core, which has at least one cover layer on each of its mutually opposite large surfaces. Recesses that extend into the interior of the foam core are introduced into the one large surface of the foam core. The at least one cover layer applied to the large surface with the recesses is provided with openings, which at least partially overlap with the recesses.

The fact that the sandwich core has a foam core and thus consists of a foam material or is a foam body means that the sandwich element has good inherent sound reduction, and therefore additional soundproofing measures are omitted or can be reduced in comparison to conventional sandwich elements with a honeycomb core. The sound-reducing effect is improved by the fact that the recesses are open, at least in certain portions, toward the outside, since a volume-to-surface area ratio that promotes soundproofing is increased.

The fact that the foam core has recesses reduces the weight of the sandwich element. The recesses are arranged in such a manner that the stability of the sandwich element is guaranteed depending on its use or location of use. Examples of shapes are blind holes, straight grooves (non-continuous slots), curved grooves, combinations of holes and grooves and the like.

In one exemplary embodiment, an opening pattern of the at least one cover layer is identical to a recess pattern of the foam core and aligned therewith. As a result, the recesses are open to the maximum on the mouth side.

In an alternative exemplary embodiment, the at least one cover layer is reticular or perforated. Such a cover layer has a large number of reticulated meshes as openings or perforations. The reticulated structure or perforation of the cover layer simplifies the production of the sandwich element, since such a cover layer does not have to be aligned with the recesses.

In order to individually adjust the soundproofing, the weight and the stability of the sandwich element, the recesses (and the openings) can have, within a foam core, different geometries (shapes), sizes and/or depths.

The soundproofing can be further improved if the foam core is open-pored or coarse-pored at least in the region of the recesses, since this further increases the effective “sound-absorbing” surface area. In principle, open-pored or closed foam cores can be used. A foam core with varying porosity is also conceivable. For example, the foam core may have a closed foam-core structure in the region of its front side and rear side, and an open-pored foam-core structure in the rest of the foam-core region, in particular in the region of the recesses. The closed surfaces improve the adhesion of the cover layers and the stability of the foam core, while the open porosity in the region of the recesses improves the sound-reducing effect.

In one exemplary embodiment, the foam core has zones with different densities. This measure makes it possible both to adjust the stability in a targeted manner and to optimize the soundproofing. For example, it is conceivable for the foam core to have a higher density along load paths than outside load paths, or for the foam core to have a higher density in the region of the recesses than in the recess-free foam-core region or vice versa.

The cover layers and the foam core preferably have the same material basis. The fact that the foam core and the cover layers are based on the same material means there is no mix of materials, and therefore the sandwich element can be easily recycled. For example, the foam core and the cover layers are based on thermoplastic polymers/materials. Preferably, the cover layers are so-called organo-sheets having a thermoplastic matrix in which reinforcing fibers such as carbon fibers or glass fibers are embedded. Examples of materials for the cover layers and the foam core are polyethersulfone (PESU) and polyetherimide (PEI). What is crucial for the choice of material is that the material meets aviation safety standards, for example regarding flammability.

In a method according to the invention for producing a sandwich element according to the invention, the recesses are introduced into the cured foam core by a machining method. Alternatively, the recesses are integrally introduced into the foam core during the production thereof.

Such a method makes it possible to introduce the recesses in a straightforward and defined manner. In contrast to the alternative introduction of the recess directly during the production of the foam core, a tool for producing the foam core can be used and then any recess pattern desired can be subsequently introduced. If the recess pattern is introduced into the foam core during foam core production, an individual tool is required for each recess pattern, but the subsequent pattern introduction is not necessary.

In one exemplary embodiment, in a first step, the recesses are introduced into the foam core, then in a second step, the at least one cover layer is applied to the foam core and subsequently in a third step, the recesses are reopened by introducing the corresponding openings into the at least one cover layer.

In another exemplary embodiment, the recesses are first of all introduced into the foam core and, in a separate process, the corresponding openings are introduced into the at least one cover layer. The cover layer is then arranged on the foam core with its opening pattern aligned with the recess pattern. The fact that the openings are introduced into the cover layer beforehand means that no distortion/displacement of the cover layer can occur when the openings or recesses are introduced.

In an alternative exemplary embodiment, in a first step, the at least one cover layer is arranged on the one large surface of the foam core. In a second step, the recesses are then introduced into the foam core through the at least one cover layer. There is no need to separately align the cover-layer openings with the recesses.

In another alternative exemplary embodiment, in a first step, the recesses are introduced into the one large surface of the foam core and then at least a reticular or perforated cover layer is arranged on this large surface. On account of the large number of reticulated meshes and perforations, there is no need for them to be separately aligned.

The at least one cover layer is preferably applied to the opposite, recess-free large surface in each case after the openings or recesses have been produced in order to avoid unintended damage thereto.

A cabin element according to the invention has a sandwich element according to the invention. The recesses are open, at least in certain portions, toward the primary structure of the aircraft. A preferred example is a sidewall-panel element, which is at least close to the engine or close to the APU, since a high noise level predominates here. The fact that the recesses are oriented with their mouths toward the primary structure means they are oriented toward the sound source, thus enabling them to fully realize their sound-reducing effect.

It is also conceivable to use the sidewall panel according to the invention to provide improved sound reduction in the first-class area. In general, using the sandwich element as a sidewall-panel element has the advantage that its large surface (in this case the rear side) provided with the recesses is not visible to the passengers, since it is arranged on the structure side, which is to the rear of the cabin, of the aircraft fuselage.

Other advantageous exemplary embodiments of the invention are the subject of further dependent claims.

Preferred exemplary embodiments of the invention will be explained in more detail below on the basis of schematic drawings, in which:

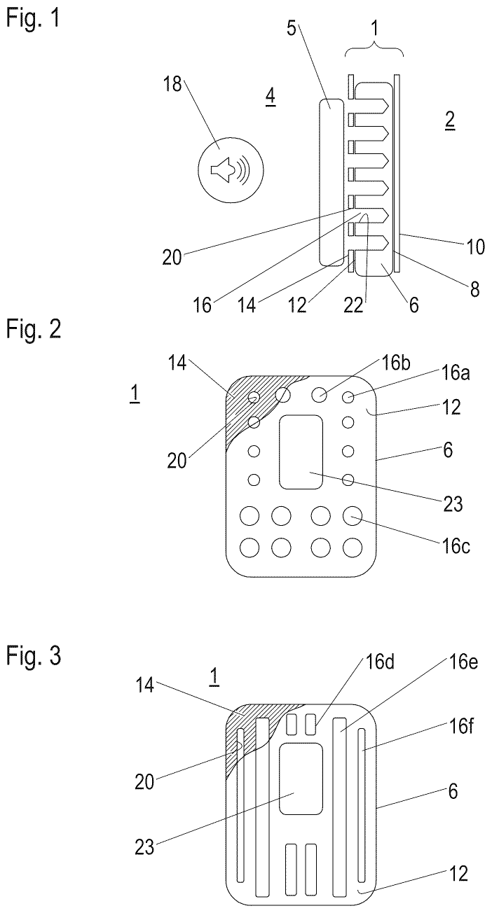

FIG. 1 shows a cross section through a first exemplary embodiment of the sandwich element according to the invention in the form of a sidewall-panel element of an aircraft cabin,

FIG. 2 shows a rear view of a second exemplary embodiment of the sandwich element according to the invention,

FIG. 3 shows a rear view of a third exemplary embodiment of the sandwich element according to the invention,

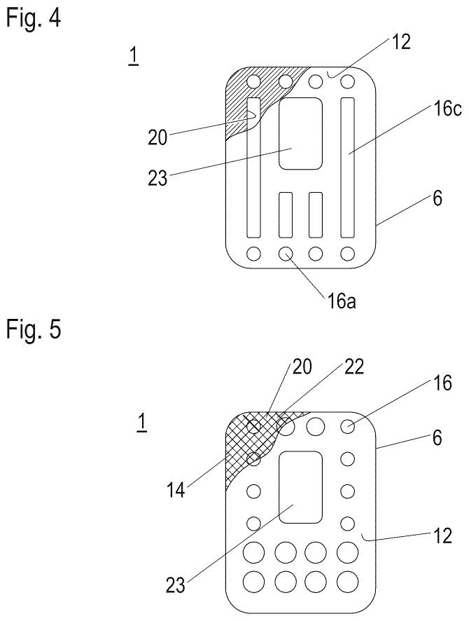

FIG. 4 shows a rear view of a fourth exemplary embodiment of the sandwich element according to the invention and

FIG. 5 shows a rear view of a fifth exemplary embodiment of the sandwich element according to the invention.

FIG. 1 shows a cross section through a first exemplary embodiment of the sandwich element 1 according to the invention in the form of a sidewall-panel element of an aircraft cabin. In its function as a sidewall-panel element, it delimits a front aircraft cabin 2 from a rear space 4 toward the primary structure of the aircraft fuselage. A plate-like soundproofing element 5 is positioned to the rear of the sandwich element 2.

The sandwich element 1 has a foam core 6, which is provided with at least one front cover layer 10 on its cabin-facing large surface 8 (hereinafter front side 8), and with at least one rear cover layer 14 on its primary-structure-facing large surface 12 (hereinafter rear side 12). The cover layers 10, 14 extend over the entire front side 8 and rear side 12, respectively, and are based, in this exemplary embodiment, on the same material as the foam core. In alternative exemplary embodiments, however, provision is also made for varying base materials of the foam core 6 and the cover layers 10, 14. In particular, the cover layers 10, 14 can also consist of different base materials from one another and thus be optimally adapted to their respective purpose (for example, orientation toward the passenger cabin or away from the sound source, respectively, or facing away from the passenger cabin or facing toward the sound source, respectively).

The cover layers 10, 14 are preferably so-called organo-sheets having a thermoplastic matrix in which reinforcing fibers such as carbon fibers or glass fibers are embedded. The foam core 6 consists of a thermoplastic foam. The intrinsic size, the thickness (extent from the front side 8 to the rear side 12), the porosity and the density or zones with different densities of the foam core are individually adjusted during the manufacturing process depending on the application.

The sandwich element 1 has a large number of rear recesses 16. The recesses 16 extend through the rear side 12 of the foam core 6 in the direction of the front side 8 without passing through the latter. In the first exemplary embodiment shown here, they are in the form of blind holes and are distributed over the entire rear side 12. Their geometry (shape), their distribution and their depth depend on the respective application and the associated required stability or possible load paths. The recesses 16 are selected and positioned so that they do not structurally weaken the cabin element.

In order to open the recesses 16 toward the rear space and thus toward the sound source 18, the rear cover layer 14 has a corresponding opening pattern consisting of a corresponding number of openings 20. The openings 20 are in this case aligned with the recesses 16. They have the same internal diameter, so that an opening cross section of the openings 20 is equal to a mouth cross section of the recesses 16.

For example, one sound source 18 is an aircraft engine. The sound enters the recesses 16 through the openings 20 and is thus at least significantly reduced in combination with the foam of the foam core 6. Advantageously, the internal walls 22 of the recesses 16 are open-pored or coarse-pored in order to enlarge an effective surface area for sound reduction.

FIG. 2 illustrates a rear view (rear plan view) of a second exemplary embodiment of the sandwich element 1 according to the invention, in which recesses 16 (here: 16a, 16b, 16c) are preferably distributed over the entire rear side 12 of the foam core 6. The sandwich element 1 is, as indicated by a window cutout 23, a sidewall-panel element. In contrast to the first exemplary embodiment, the recesses 16 in some areas of the sandwich element 1 are provided with a smaller internal diameter than in other areas of the sandwich element 1 (small internal diameter see recesses 16a, medium internal diameter see recesses 16b, large internal diameter see recesses 16c). The at least one rear cover layer 14 is provided with a corresponding opening pattern.

FIG. 3 shows a rear view (rear plan view) of a third exemplary embodiment of the sandwich element 1 according to the invention. In contrast to the first exemplary embodiment and the second exemplary embodiment, rear recesses 16 (here: 16d, 16e, 16f) are in the form of straight grooves at least having different widths and lengths. Depending on the application, arcuate or curved grooves as well as different depths of the grooves are of course also conceivable. As in the first exemplary embodiment and in the second exemplary embodiment, the at least one rear cover layer 14 is provided with a corresponding opening pattern.

FIG. 4 shows a rear view (rear plan view) of a fourth exemplary embodiment of the sandwich element 1 according to the invention. It depicts a combination of blind-hole-like recesses 16a with groove-like recesses 16d. As in the first and second exemplary embodiments, the at least one rear cover layer 14 is provided with a corresponding opening pattern of round openings 20 and elongate openings.

FIG. 5 shows a rear view (rear plan view) of a fifth exemplary embodiment of the sandwich element according to the invention. As in the first exemplary embodiment, the foam core 6 has a recess pattern consisting of a large number of rear recesses 16. In contrast to all the abovementioned exemplary embodiments according to FIGS. 1, 2, 3 and 4, the at least one rear cover layer 14 of the fourth exemplary embodiment is reticular or perforated. The rear cover layer 14 thus has a large number of reticulated meshes or perforations as openings 20, which have a small opening cross section than the recesses 16. As a result of the large number of reticulated meshes or perforations in combination with the thin webs 22 forming them, the recesses 16 can nevertheless be regarded as fully open on the mouth side. Depending on the surface structure of the rear wall 16, the reticulated meshes may also be larger than the mouth regions of the recesses 16.

It should be mentioned that, even if not illustrated, features of individual exemplary embodiments may be combined with one another.

The invention discloses a sandwich element having a foam core, which has at least one cover layer on each of its mutually opposite large surfaces, wherein recesses are introduced into the one large surface of the foam core, and the at least one cover layer extending over this large surface is provided with openings, which at least partially overlap with the recesses, a production method and a cabin element.

### LIST OF REFERENCE SIGNS

1 sandwich element

2 aircraft cabin

4 rear space

5 soundproofing element

6 foam core

8 large surface (here: front side)

10 front cover layer

12 large surface (here: rear side)

14 rear cover layer

16 recess

18 sound source

20 opening

22 internal wall

23 window cutout

24 web

1. A sandwich element having a foam core, which has at least one cover layer on each of its mutually opposite large surfaces, wherein recesses are introduced into the one large surface of the foam core, and the at least one cover layer extending over this large surface comprises openings, which at least partially overlap with the recesses.

2. The sandwich element as claimed in claim 1, wherein an opening pattern of the at least one cover layer is identical to a recess pattern of the foam core and is aligned therewith.

3. The sandwich element as claimed in claim 1, wherein the at least one cover layer is reticular or perforated.

4. The sandwich element as claimed in claim 1, wherein, within a foam core, the recesses have different shapes, sizes and/or depths.

5. The sandwich element as claimed in claim 1, preceding claims, wherein the foam core is open-pored or coarse-pored in a region of the recesses.

6. The sandwich element as claimed in claim 1, wherein the foam core has zones with different densities.

7. The sandwich element as claimed in claim 1, wherein the cover layers have a same material basis as the foam core.

8. A method for producing a sandwich element as claimed in claim 1, wherein the recesses are introduced into the cured foam core by a machining method or integrally during production of the foam core.

9. A cabin element of an aircraft having the sandwich element as claimed in claim 1, wherein the recesses are open, at least in certain portions, toward a primary structure of the aircraft.
